(19) United States
(12) Patent Application Publication
(10) Pub. No.: US 2008/0132636 A1
(43) Pub. Date: Jun. 5, 2008

(54) Nylon monofilaments and process for preparing nylon monofilaments for the production of spiral fabrics and seam wires

(76) Inventors: Gilbert Ross, Waycross, GA (US); Heping Zhang, Summerville, SC (US); Craig Valentine, Summerville, SC (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 10/860,229

(22) Filed: Jun. 3, 2004

(51) Int. Cl. C08L 77/06; D02G 3/00; D01D 5/08

(52) U.S. Cl. 524/538; 428/401; 264/178 F

(57) ABSTRACT

Nylon monofilament and process for preparing a nylon monofilament manufactured from a blend of about 60 to about 90% polyamide 66, about 10 to about 40% of a polyamide copolymer and 0 to about 5% of at least one other additive. The monofilament can be formed into helical coils particularly useful for the formation of spiral industrial fabrics and spiral seams used in industrial fabrics, such as, but not limited to paper machine clothing.

### BACKGROUND OF THE INVENTION

This invention relates to a nylon monofilament and process for converting said composition into monofilaments. The monofilaments are free from voids within the structure and possess suitable mechanical and thermal properties to be formed into helical coils particularly useful for the formation of spiral industrial fabrics and spiral seams used in industrial fabrics, e.g., paper machine clothing.

Currently, the only spiral fabrics available on the market are made from polyethylene terephthalate (PET), polyphenylene sulfide (PPS), polyetheretherketone (PEEK) or some alloys which do not have the same properties as nylon when used for wet applications such as in belt presses and in chemi-washers of papermaking machines. Seams for nylon fabrics are currently provided by a PEEK spiral, which is brittle under high tension, or an Inox Steel strand coated with polyamide spiral which is soft, difficult to assemble and more prone to abrasion than a nylon spiral seam provide by the nylon monofilament of the present invention.

Nylon monofilaments are typically prepared by melt extrusion, a process whereby the polymer is converted into a uniform melt by passing through an extruder. The molten filaments are then run into a liquid quenching media to effect solidification. The solidified strands are oriented by drawing in a heated medium, typically hot air, water or steam. Finally, the strands are annealed at temperatures ranging from 100° C. to 250° C. depending upon the final properties desired. The conditions of the process influence the thermal shrinkage of the finished filament.

U.S. Pat. No. 4,423,543 discloses a method for producing spiral fabrics by connecting a plurality of helical coils using monofilament pintle wires. The process of forming the helical coil involves thermal fixation of the filament as it is wrapped around a steel mandrel at high speed, typically up to 2400 rpm. Due to the length of the fixation heater, the yarn is exposed to the heat for only a few seconds, and therefore the fixation must be very fast for the production of a uniform coil. To facilitate this, monofilaments for spiral production normally have higher thermal shrinkage. Generally this involves the oriented amorphous portion of the polymer chain re-arranging to a lower energy state. Hence it is desirable to maximize the oriented amorphous region of the polymer chains to facilitate a fast and uniform thermal shrinkage.

Nylon is a desirable material for the formation of spiral coils, and in particularly for the formation of helical coils in spiral industrial fabrics, because Nylon has excellent abrasion resistance and good chemical resistance in alkaline conditions when compared to polyester monofilaments. Polyamide 66 (hereafter “PA 66”) is preferred over polyamide 6 (hereafter “PA 6”) because of its higher melting point, lower equilibrium moisture content and higher modulus retention after conditioning. However, PA 66 is unsuitable for formation of spiral coils due to a number of factors, to with:

It is known to those versed in the art that when producing PA 66 monofilaments in excess of 0.60 mm in diameter there is a tendency for the formation of voids within the filament. These voids cause a reduction in tensile strength and toughness of the fiber. This is particularly undesirable when using the yarn in a seam of a fabric employed on papermaking machines, where voids can result in a fracture of the seam. In addition to the loss of mechanical properties, the thermal shrinkage is non-uniform in the vicinity of a void, which causes an undesired defect when the spiral is formed. For smaller diameter monofilaments (less than 0.60 mm) the surface to volume ratio is reduced relative to the larger diameter monofilaments. This reduction in the surface to volume ratio results in a more efficient heat transfer from surface to core, which in turn reduces the incidence of void creation. However, since most of the monofilaments utilized in the spiral formation of industrial fabrics are 0.70 mm in diameter or greater, monofilaments made from PA 66 are not desirable for use in such fabrics.

Typical PA 66 monofilaments are highly crystalline, with large crystals visible as spherullites under a polarizing microscope. This leads to a stable structure with the oriented amorphous region being undesirably low, resulting in thermal shrinkage that is undesirably low and slow.

The loops of a spiral fabric are held together by pintle monofilaments inserted through the loops. The loop strength of the filament can be used to simulate the contribution of the yarn to fabric strength. It is known that PA 66 monofilaments will fail in a brittle mode when a loop is fractured. Such brittle failure is undesirable in a spiral yarn, particularly when the spiral is in the seam of an industrial fabric.

U.S. Pat. No. 6,238,608 addresses the problem of void formation by blending PA 66 with PA 6. Preferably, the PA 6 is added at 15% loading to eliminate the voids.

EP230228 discloses a method for producing spiral fabrics from monofilaments made from a blend of PA 66 and PA 6.

U.S. Pat. No. 6,451,412 discloses a method for introducing a spiral helical coil into the seam of a woven fabric.

All references cited herein, including earlier cited U.S. Pat. No. 4,423,543 are incorporated herein by reference in their entireties.

### SUMMARY OF THE INVENTION

Monofilaments in accordance with this invention are a blend comprising: (a) about 60 to about 90% PA 66, by weight; (b) about 10 to about 40% of a polyamide copolymer, by weight; and (c) 0 to about 5% of one or more additional additives, by weight. These additives, when included in the blend, can be a variety of different materials, including but not limited to processing aids and heat stabilizers. The polyamide copolymer can be either polyamide 6/66 (i.e., polyamide 6 constituting over 50%, by weight, of the polymer composition) or polyamide 66/6 (i.e., polyamide 66 constituting over 50%, by weight, of the polymer composition).

All references to percentages of polymers or other materials refer to percentage by weight unless indicated otherwise.

Monofilaments in accordance with this invention are substantially free from voids within the structure and preferably have a linear relationship of extension to applied load for tensile loads below 3. gpd. In addition, the monofilaments of this invention preferably possess a single, broad melting peak greater than 230° C., and a single cooling crystallization peak, as determined by a differential scanning calorimeter (DSC). Moreover, monofilaments of the present invention preferably have a diameter of from about 0.20 mm to 1.4 mm, and more preferably in the range of from about 0.40 to 1.20 mm. In preferred embodiments of this invention the monofilaments are employed to form helical coils particularly useful for the formation of spiral industrial fabrics and spiral seams used in industrial fabrics, e.g., paper machine clothing.

A process in accordance with this invention for forming monofilaments includes the steps of:

melt blending a composition comprising about 60 to about 90% PA 66, about 10 to about 40% of a polyamide copolymer and 0 to about 5% of one or more additional additives, at a temperature from about 260° C. to about 300° C.;

extruding the melt blended composition through a die for forming molten filaments;

quenching the molten filaments in water at a temperature greater than about 50° C.;

drawing the quenched filaments in a suitable media such as hot air, water or stream at a total draw ratio greater than about 3.0; and

annealing the drawn filaments at a temperature greater than about 100° C. and less than about 250° C.

Employing the above process results in the formation of monofilaments in which a linear correlation between the tensile load applied and the extension of the monofilament is maintained such that when the monofilaments are subjected to thermal fixation in a spiral process the response will be fast and uniform, thereby resulting in the formation of the desired coil. Spiral processes for forming industrial fabrics, e.g., papermaking fabrics, are well known in the art, as exemplified by the disclosure in the earlier-identified '543 patent, which already has been incorporated by reference herein. Therefore, no further explanation of the spiral forming process or the structure of spiral formed industrial fabrics is necessary.

Uses for the monofilaments of the present invention include, without limitation: (1) supplying a nylon spiral fabric to the market for wet forming applications, specifically for belt presses and chemi-washer applications in papermaking machines and (2) supplying a nylon spiral seam to nylon woven fabrics for wet applications. An advantage of a nylon spiral fabric is that it gives much better abrasion resistance than a polyester, PPS or PEEK spiral fabric when applied for wet applications. Further advantages of a nylon spiral seam over a polyester, PPS or PEEK seam are that the nylon spiral seam gives much better resilience under load, better abrasion resistance and is easier to seam when applied for wet applications such as for belt presses and chemi-washers where Nylon is preferred.

### BRIEF DESCRIPTION OF SEVERAL VIEWS OF THE DRAWINGS

The invention will be described in conjunction with the following drawings in which like reference numerals designate like elements and wherein:

FIG. 1 is a graph illustrating the linear response of elongation to applied load in filaments of this invention;

FIG. 2 illustrates DSC cooling crystallization curves for a typical prior art PA 66 monofilament and a monofilament of the present invention illustrating the reduction in the rate of crystallization and the degree of crystallinity for the invention; and

FIG. 3 depicts various cross-sectional configurations of monofilaments embodied in the invention.

### DETAILED DESCRIPTION OF THE INVENTION

A monofilament in accordance with this invention includes a blend of between about 60 to about 90% polyamide 66, about 10 to about 40% of a polyamide copolymer and 0 to about 5% of other additives. When other additives are employed they may include, without limitation, processing aids, stabilizers and other materials that improve the monofilament's performance in its specific application.

The PA 66 suitable for use in this invention is more accurately referred to as polyhexamethylene adipamide and has a CAS nomenclature and registration number of Poly[imino(1,6-dioxo-1,6-hexanediyl)imino-1,6-haxanediyl] and 32131-17-2, respectively. Suitable PA 66 is prepared from the polymerization of hexamethylene diamine and adipic acid, or the salt derived thereof. By way of example, a continuous process for the production of this polymer is described in U.S. Pat. No. 3,948,862, the disclosure of which is fully incorporated by reference herein.

The relative viscosity of the PA 66 preferably is in the range of 50 to 250 as determined according to ASTM D789, and preferably between 100 to 150. Appropriate commercial grades are exemplified by, but not limited to those available from E.I. Dupont de Nemours and Co. under the trade name of Zytel, and from Nilit Ltd under the trade name Polynil.

The polyamide copolymer is exemplified by, but not limited to that prepared from the polymerization of hexamethylene diamine, adipic acid and caprolactam, or salts thereof. Such copolymers are commonly referred to as polyamide 6/66 (hereafter PA 6/66) or polyamide 66/6 (hereafter 66/6) depending upon the ratio of polyhexamethylene adipamide and polycaprolactam units in the copolymer. If the copolymer contains a greater proportion of PA 66 units, by weight, it is described as PA 66/6, and conversely if it contains a greater proportion of polyamide 6 units, by weight, it is referred to as PA 6/66. The polyamide copolymer preferred for use in this invention may comprise a variety of ratios of PA 6 to PA 66 units, by weight, but preferably is of the type including over 50%, by weight, PA 6 units. The most preferred ratio usable in this invention is 85 to 15 PA 6 to PA 66, respectively. PA 6 described herein is more accurately referred to as polycaprolactam and has a CAS nomenclature and registration no. of poly[imino(1-oxo-6-hexanediyl)] and 25038-54-4, respectively.

The relative viscosity of suitable polyamide copolymers preferably is in the range of 50 to 250, and more preferably in the range of 130 to 180 as determined by ASTM D789. Appropriate polyamide copolymers are exemplified but not limited to those commercially supplied by BASF Corp. under the trade name Ultramid and from NYCOA under the trade name Nyltech.

Additives that may be incorporated to improve performance include, but are not limited to lubricants such as metal stearates or fatty acid amides, and anti-oxidants of the hindered phenolic, phosphate or copper salt type.

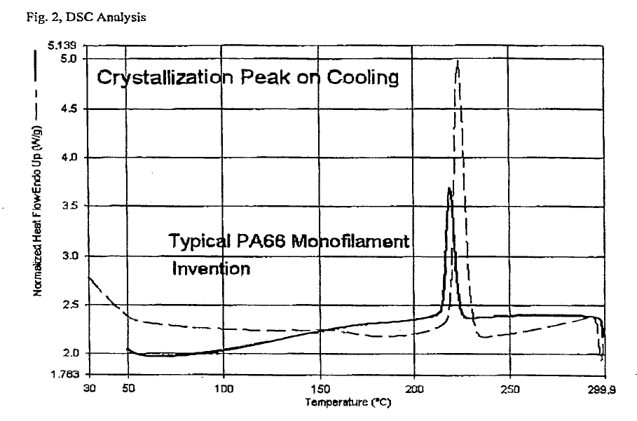

Monofilaments made from the aforementioned blends in accordance with this invention have a reduction in the crystallization rate and the overall crystallinity as measured using DSC, when compared to a PA 66, by itself. In particular, FIG. 2 illustrates the difference between a typical PA 66 monofilament and the present invention.

It has been determined that the undesired formation of voids occurs as a result of the non-uniform cooling of the extruded melt, i.e., the outside surface of the extruded melt solidifying while the core is still molten and crystallizing. By reducing the crystallization rate and overall crystallinity in the filaments of this invention, the structure at the surface and in the core of the formed monofilament is more uniform during the quenching process, thereby reducing the tendency to form voids in the interior of the monofilament.

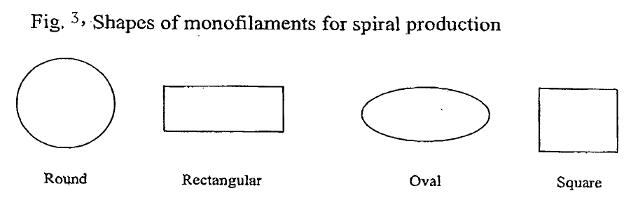

The monofilaments described herein are single filaments that can be of a variety of different shapes, as exemplified in FIG. 3. However, the specific shape of the filament is not a limitation on the broadest aspects of this invention and other shapes may also be employed. The preferred monofilaments of this invention have a denier greater than 500 and more desirably greater than 1800. Formation of the monofilaments is achieved by melt blending the polymers and extruding the melt through a suitable series of orifices in an extrusion die. A gear pump is used to maintain a constant flow of the polymer through said die. Such blending and extrusion equipment are well known in the art and need no further description. The extruded molten filaments are quenched in water at a temperature less that 70° C., and taken up by a godet roll at a speed of 5 to 100 m/min. The filaments are then drawn at a ratio greater than 3.0 at a temperature between 60° C. and 220° C. The oriented filaments are annealed at a temperature no greater than the melting point of the composition.

The monofilaments thus formed were subjected to various mechanical and thermal tests. The physical properties were determined according to ASTM D2256-97, and the thermal shrinkage was established according to ASTM D204 with the temperature of the test adjusted to 176.7° C. (350° F.). The loop tenacity was measured using a modification of ASTM D2256-97, where the single filament was replaced with two monofilaments looped through each other and clamped into the jaws of an Instron Tensile Tester.

Thermal analysis of the monofilaments was performed using a Perkin Elmer DSC 7. The melting point was determined by ramping the temperature from 30° C. to 280° C. at a rate of 20° C./min. The sample was then held at 280° C. for 3 minutes before being cooled back to 30° C. at the rate of 20° C./min, in order to determine the crystallization temperature on cooling. The sample weight was maintained at approximately 10 mg for each test.

The invention will be illustrated in more detail with reference to the following Example, but it should be understood that the present invention is not deemed to be limited thereto.

### EXAMPLE 1

The following example describes the formulation and the mechanical properties of a monofilament in accordance with this invention. A formulation of 90% PA 66 and 10% PA 6/66 was employed for this example.

The PA 66 used in this example had a relative viscosity (RV) of 125. The PA 6/66 copolymer used had a ratio of 85 to 15 PA 6 to PA 66 units, respectively. Such resins are exemplified by, but not limited to Zytel 3071 from Du Pont and C4 from BASF respectively.

Monofilament extrusion was carried out on a 1″ single screw extruder with an L/D ratio of 25:1. The resins were gravity fed into the extruder from a hopper, into which a positive pressure of nitrogen gas was maintained to prevent moisture ingress.

The physical properties of this monofilament as produced were measured according to ASTM D2256-97. The shrinkage was tested according to ASTM D204 with the temperature modified to 176.7° C.

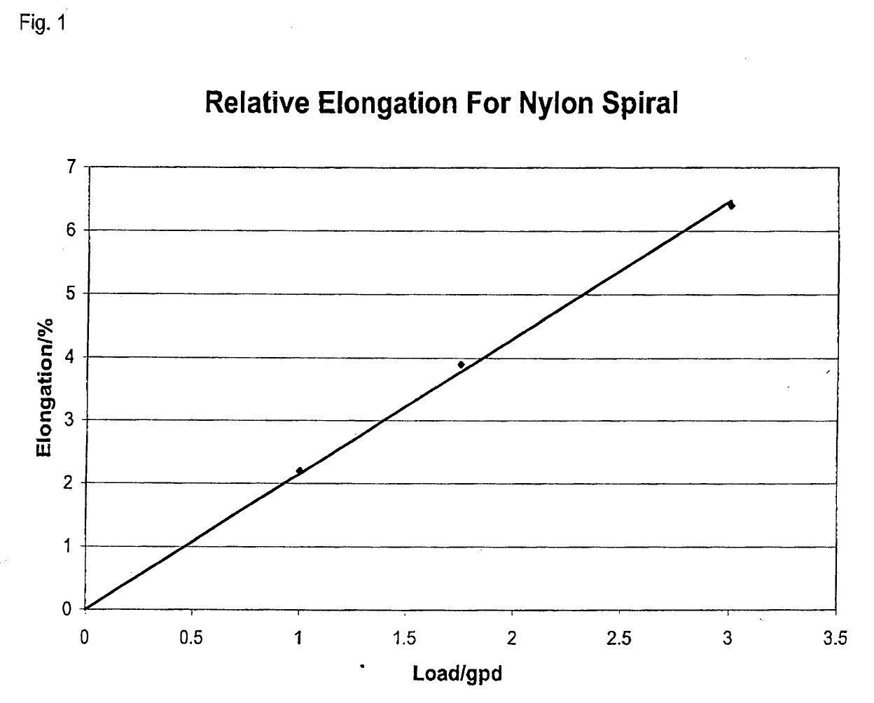

The physical properties of the monofilament so formed are provided in Table 1 below, and the relationship of elongation to applied load is shown in FIG. 1.

TABLE 1

| Sample | Extrusion melt | | Tenacity | Elongation at | Shrink- |
|---|---|---|---|---|---|
| No. | temperature (° C.) | Denier | (gpd) | break (%) | age (%) |
| 1 | 280 | 4800 | 3.8 | 25 | 14.5 |

While the invention has been described in detail and with reference to a specific example thereof, it will be apparent to one skilled in the art that various changes and modifications can be made therein without departing from the spirit and scope thereof.

What is claimed is:

1. A nylon monofilament comprising: (a) about 60 to about 90% polyamide 66; (b) about 10 to about 40% of a polyamide copolymer; and (c) 0 to about 5% of at least one other additive.

2. The nylon monofilament of claim 1, wherein said at least one other additive is a processing aid, a stabilizer, or another material that improves the performance of the nylon monofilament.

3. The nylon monofilament of claim 1, wherein said at least one other additive is a lubricant or an anti-oxidant.

4. The nylon monofilament of claim 3, wherein said lubricant is a metal stearate or a fatty acid amide and the anti-oxidant is of the hindered phenolic, phosphite or copper salt type.

5. The nylon monofilament of claim 1, wherein said polyamide copolymer is a copolymer of polyamide 66 and polyamide 6.

6. The nylon monofilament of claim 5, wherein said polyamide copolymer contains over 50% by weight polyamide 6 units, by weight.

7. The nylon monofilament of claim 6, wherein said polyamide copolymer has a ratio of 85 to 15 polyamide 6 units to polyamide 66 units, by weight.

8. The nylon monofilament of claim 1 having a relative elongation that is linearly proportional to applied load in the range of 1 to 3 gpd loading and is substantially free from voids.

9. The nylon monofilament of claim 1 having a diameter of from about 0.20 to about 1.4 mm.

10. The nylon monofilament of claim 9 having a diameter of from about 0.40 to about 1.20 mm.

11. The nylon monofilament of claim 1, having a cross-sectional shape that is round, rectangular, oval, or square.

12. The nylon monofilament of claim 1 having a denier greater than 500.

13. The nylon monofilament of claim 12, having a denier greater than 1800.

14. A process for producing a nylon monofilament useful in industrial fabrics, said process comprising the steps of: (a) melt blending at a temperature from about 260° C. to about 300° C. a mixture of: (i) about 60 to about 90% polyamide 66; (ii) about 10 to about 40% of a polyamide copolymer; and (iii) 0 to about 5% of at least one other additive; (b) extruding the mixture through a die to form a molten monofilament; (c) quenching the molten monofilament in water at a temperature greater than about 50° C. to solidify said monofilament; (d) drawing the monofilament at a total draw ratio greater than about 3.0; (e) annealing the drawn monofilament at a temperature greater than about 100° C. and less than about 250° C.

15. The process of claim 14, wherein said at least one other additive is a lubricant or an anti-oxidant.

16. The process of claim 15, wherein said lubricant is a metal stearate or a fatty acid amide and said anti-oxidant is of the hindered phenolic, phosphite or copper salt type.

17. The process of claim 14, wherein said polyamide copolymer is a copolymer of polyamide 66 and polyamide 6.

18. The process of claim 17, wherein said polyamide copolymer contains more than 50% polyamide 6 units, by weight.

19. The process of claim 18, wherein said polyamide copolymer has a ratio of about 85 to about 15 polyamide 6 units to polyamide 66 units, by weight.

20. The process of claim 14, wherein said quenching step is carried out in water at a temperature less than 70° C.

21. The process of claim 14, wherein said drawing step is carried out at a temperature between 60 and 220° C.
